(19) United States
(12) Patent Application Publication
(10) Pub. No.: US 2009/0106998 A1
(43) Pub. Date: Apr. 30, 2009

(54) Hair Dryer and Vacuum Device

(76) Inventor: Pauline Brown-Carter, Wellington, FL (US)

Correspondence Address: HARSHAW RESEARCH, INC., 210 W. TECUMSEH STREET, OTTAWA, KS, 66067, US

(21) Appl. No.: 12/244,483

(22) Filed: Oct. 2, 2008

Related U.S. Application Data
(63) Continuation-in-part of application No. 11/346,433, filed on Dec. 19, 2006, now abandoned.

(51) Int. Cl. F26B 19/00; F26B 13/30; A45D 20/12; A47L 9/10

(52) U.S. Cl. 34/90; 34/92; 34/97; 15/347

(57) ABSTRACT

A hair dryer and vacuum device includes a housing having a nozzle, a handle, and a body portion situated between the handle and nozzle, the nozzle including a first channel extending from the body portion to an outlet port and a second channel extending from the body portion to an inlet port. A heating coil is mounted in the body portion for heating air and a dryer fan is positioned adjacent the heating coil that is configured to blow the heated air through the outlet port when energized. A vacuum fan is mounted in the second channel and configured to draw air into the second channel through the inlet port when energized. The device includes a collection chamber situated between the vacuum fan and the body portion and in communication with the second channel such that fallen hair is collected therein.

### CROSS REFERENCE TO RELATED APPLICATIONS

This application is a continuation-in-part application that claims the benefit of U.S. application Ser. No. 11/346,433 filed Dec. 19, 2006 and titled Penny's Portable Compact Hair Dry/Vacuum.

### BACKGROUND OF THE INVENTION

This invention relates generally to a hair care accessory and, more particularly, to a hair dryer having a vacuum suction assembly for selectively collecting fallen hair.

Hot air blowing devices are commonly used by beauticians and barbers in the process of cutting and styling a person's hair. A natural consequence and inconvenience following the cutting of hair is collecting it for disposal. Picking up fallen hair typically requires the use of a broom and dust pan and then stooping over to pick up the dust pan to dump it in a trash receptacle. Unfortunately, the act of repetitively stooping to pick up collected hair may be painful back soreness and frustration.

Therefore, it would be desirable to have a hair dryer and vacuum device for selectively blowing wet hair dry or vacuuming fallen hair. Further, it would be desirable to have a hair dryer and vacuum device that can blow hot air through one channel of a nozzle or suction air through another channel of the nozzle.

### SUMMARY OF THE INVENTION

A hair dryer and vacuum device according to the present invention includes a housing having a nozzle, a handle, and a body portion situated between the handle and the nozzle, the nozzle including a first channel extending from the body portion to an outlet port and a second channel extending from the body portion to an inlet port. A heating coil is mounted in the body portion for heating air and a dryer fan is positioned adjacent to the heating coil that is configured to blow the heated air from the body portion through the first channel outlet port when energized. A vacuum fan is mounted in the second channel that is configured to draw air into the second channel through the second channel inlet port when energized. The device includes a collection chamber situated between the vacuum fan and the body portion and in communication with the second channel such that fallen hair is collected therein.

Objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a hair dryer and vacuum device according to a preferred embodiment of the present invention;

FIG. 1b is an isolated view on an enlarged scale taken from a portion of FIG. 1a;

FIG. 2a is an exploded view of the device as in FIG. 1a;

FIG. 2b is an isolated view on an enlarged scale taken from a portion of FIG. 2a;

FIG. 3 is a side view of the device as in FIG. 1a with a collection chamber door in a closed configuration;

FIG. 4a is a side view of the device as in FIG. 3 with the collection chamber door in an open configuration;

FIG. 4b is an isolated view on an enlarged scale taken from a portion of FIG. 4a;

FIG. 5 is a fragmentary view of the device as in FIG. 1 with a portion of the housing wall being removed for clarity;

FIG. 6 is a front view of the device as in FIG. 1a; and

FIG. 7 is a sectional view taken along line F7-F7 of FIG. 6.

### DESCRIPTION OF THE PREFERRED EMBODIMENT

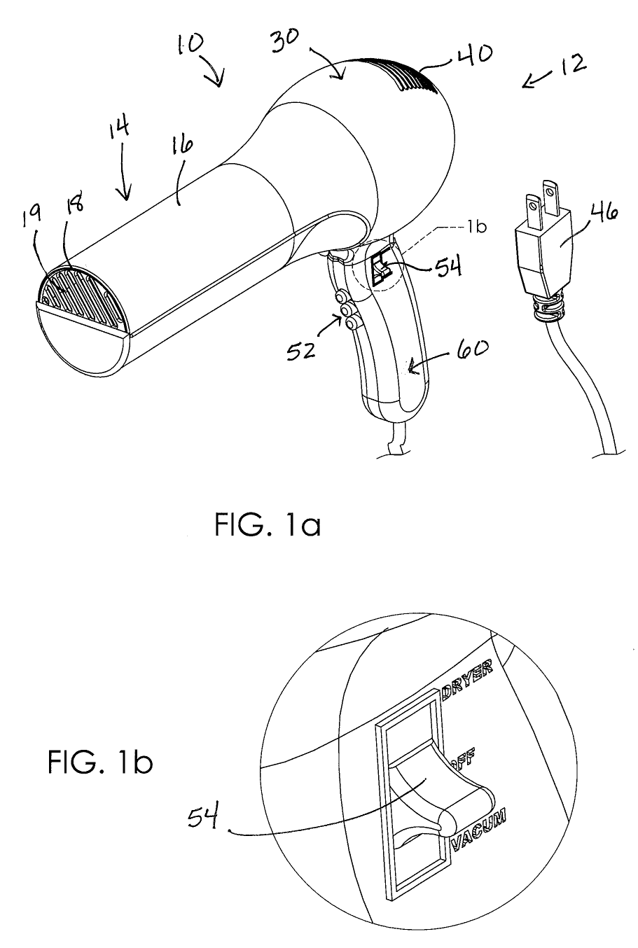

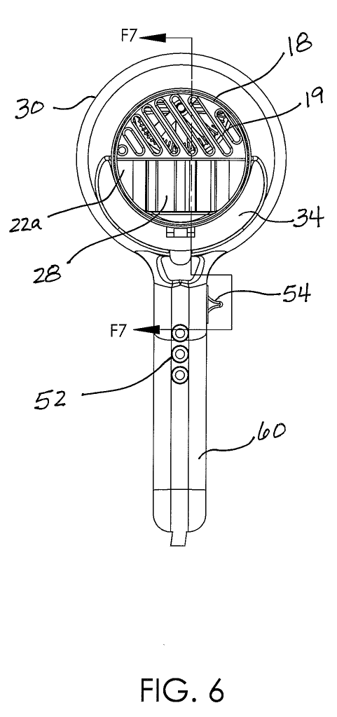

A hair dryer and vacuum device according to a preferred embodiment of the present invention will now be described with reference to FIGS. 1a to 7 of the accompanying drawings.

More particularly, the hair dryer and vacuum device 10 includes a housing 12 having a nozzle 14, a handle 60, and a body portion 30 situated between the handle 60 and nozzle 14 (FIG. 1a). The device 10 presents an overall configuration that is similar to that of a traditional blow dryer but with several unique structures and functions as will be further described below. It is understood that the nozzle 14 and body portion 30 define generally hollow interior areas.

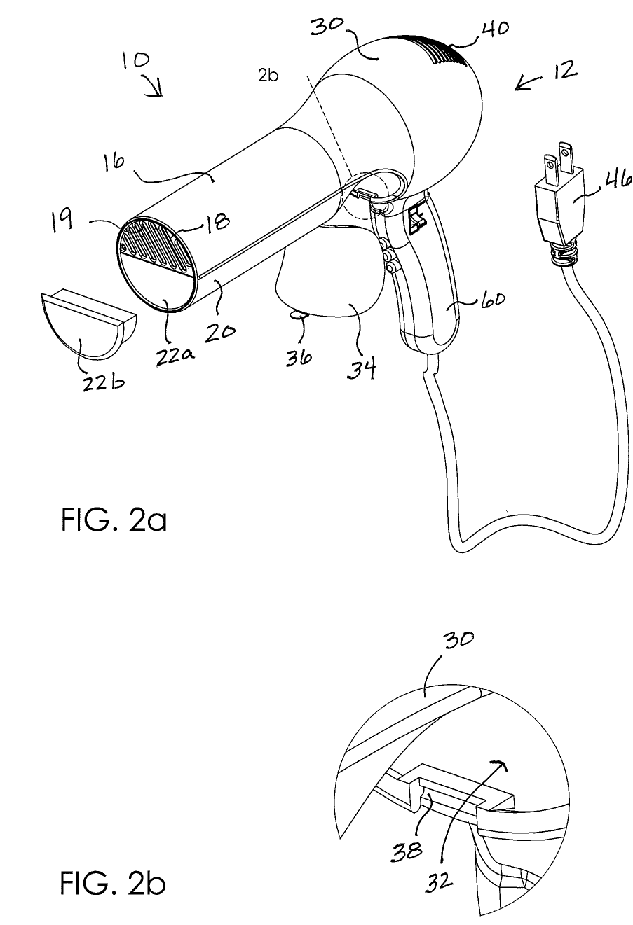

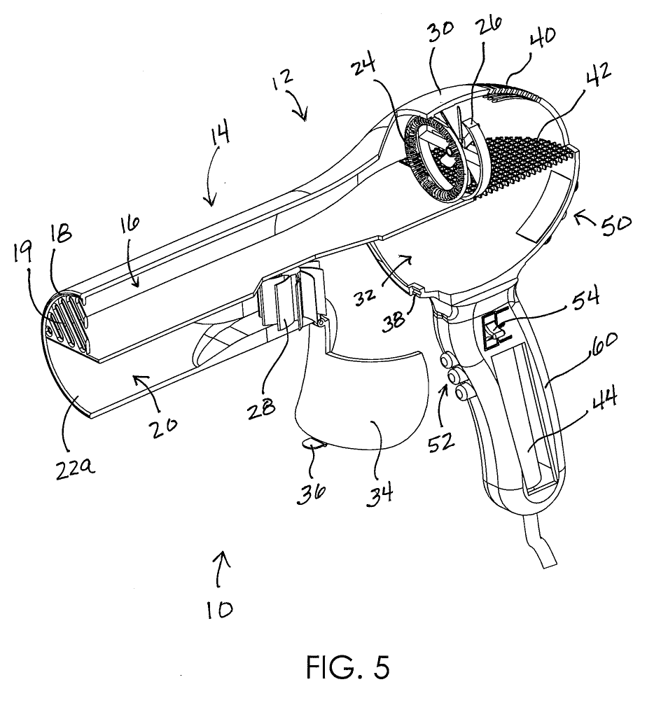

The nozzle 14 includes a first channel 16 extending from body portion 30 to a distal end defining an outlet port 18 (FIG. 5). The nozzle 14 also includes a second channel 20 extending generally from the body portion 30 to a distal end defining an inlet port 22. The inlet 22 and outlet 18 ports are adjacent one another and, more particularly, the outlet port 18 is positioned atop the inlet port 22a. Accordingly, the first channel 16 is positioned atop the second channel 20. The hollow first channel 16 is in communication with the hollow body portion 30 although the hollow second channel 20 is not in communication with the hollow interior area of the body portion 30. An inlet port insert 22b may be included so as to plug the second channel when not in use (FIGS. 1a and 2a).

A heating coil 24 is mounted within the hollow interior of the body portion 30 of the housing 12. The heating coil 24 is able to heat ambient air within the body portion 30 when it is electrically energized. A dryer fan 26 is mounted in the interior area of the body portion 30 and positioned rearwardly adjacent the heating coil 24. The dryer fan 26 includes blades configured to blow the heated air through the first channel 16 and out the outlet port 18 when electrically energized. The outlet port 18 may include a grating or grill 19 so as to prevent objects from being inadvertently inserted into the first channel 16 as this may result in contact with the heating coil 24.

Further, the hair dryer and vacuum device 10 includes a vacuum fan 28 mounted within the second channel 20 of the nozzle 14 (FIG. 5). The vacuum fan 28 may include blades configured to draw air into the second channel 20 through the inlet port 22 when electrically energized. Accordingly, this structure is operable to selectively suction fallen air into the second channel 20.

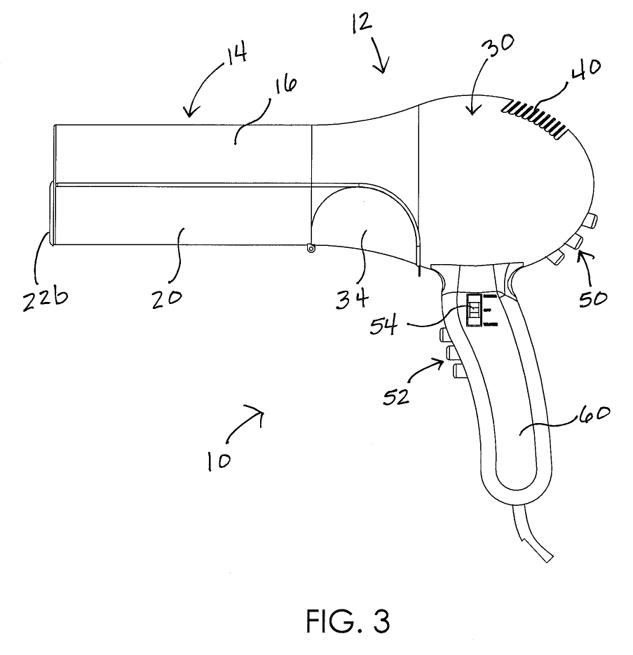

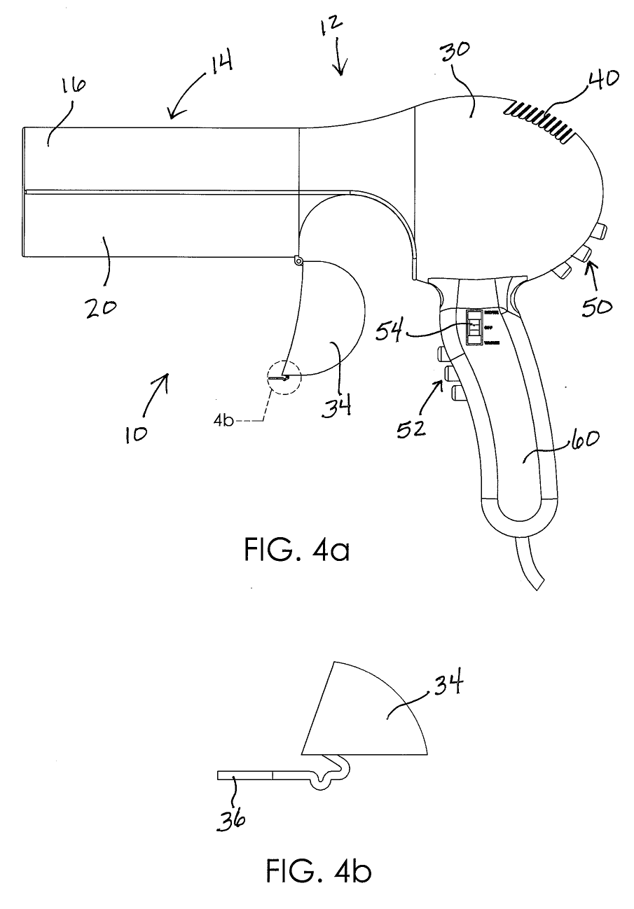

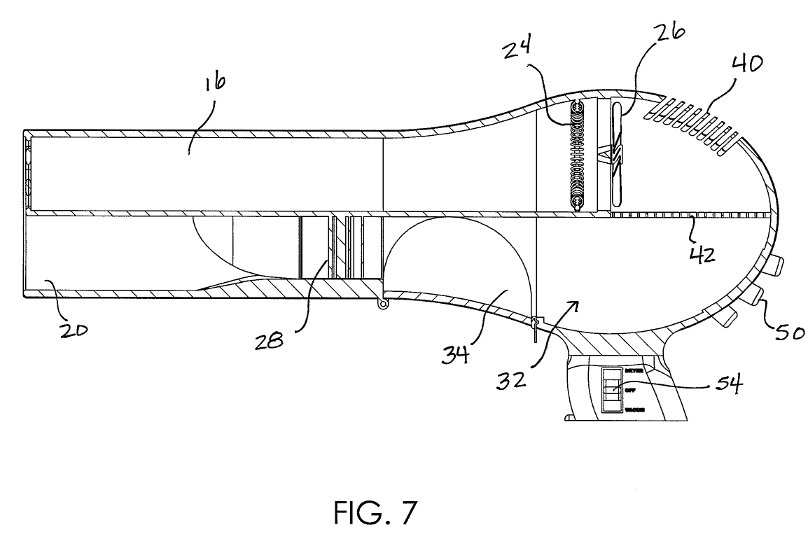

The body portion 30 of the housing 12 defines a collection chamber 32 separate and not in communication with the interior of the body portion (FIG. 5). The collection chamber 32, however, is in communication with the second channel 20. A door 34 is operatively coupled to an underside of the housing 12 and, more particularly, to the second channel 20, that is movable between an open configuration providing access to the collection chamber (FIGS. 2a, 4a, and 5) and a closed configuration (FIGS. 3 and 7) enclosing the collection chamber 32. The door 34 includes a fastener 36 mounted or integrally formed along a free edge thereof (FIG. 2a). The body portion 30 defines a groove 38 having a configuration that is complementary to that of the fastener 36 (FIG. 2b) for selectively receiving the fastener and securing the door 34 in the closed configuration (FIG. 3) and that enables a user to release the door 34 to its open configuration (FIG. 4a) by manipulating the fastener 36 with his fingers. The fastener 36 may be constructed of a flexible plastic material or even spring steel such that it is flexible for easy manipulation (FIG. 4b).

Further, the body portion 30 of the housing 12 includes a vent opening 40 positioned in proximity to the dryer fan 26 such that ambient air may be drawn into the interior space to be heated when the heating coil 24 and dryer fan 26 are energized. A filter 42 may be situated between the vent opening 40 and the dryer fan 26 for collecting contaminants from the ambient air such that they are not blown through the first channel 16 by the fan.

The hair dryer and vacuum device 10 includes a power source for energizing the electrical components therein. The components may be powered by a battery or by traditional AC electricity. More particularly, a battery 44 may be positioned in the handle 60 and be electrically connected to the dryer fan 26, heating coil 24, and vacuum fan 28. Alternatively, or additionally, an electrical power cable and plug 46 may extend from the handle 60 and be electrically connected to the dryer fan 26, heating coil 24, and vacuum fan 28.

A first input 50 may be mounted to the housing 12 and electrically connected to the power source as well as to the heating coil 24 and dryer fan 26. The first input 50 may include high, medium, and low power setting buttons although other means for controlling the dryer fan 26 may be included, such as a dial or more/fewer controls. Preferably, the first input 50 is positioned on an exterior of the body portion 30 (FIG. 3) although being positioned on the handle 60 or other convenient location would also be suitable.

A second input 52 may be mounted to the housing 12and electrically connected to the power source as well as to the vacuum fan 28. The second input 52 may include high, medium, and low power setting buttons although other means for controlling the vacuum fan 28 may be included, such as a dial or more/fewer controls. Preferably, the second input 52 is positioned on a front edge of the handle 60 (FIG. 1a) although being positioned on the body portion 30 or other convenient location would also be suitable.

Further, the device 10 includes a switch 54 electrically connected to the power source and to the first 50 and second 52 inputs and configured to selectively energize one of the inputs and, thus, energizing either the dryer fan 26 and heating coil 24 or the vacuum fan 28.

In use, a user may either connect the electric power plug 46 to an AC outlet or else rely on the battery 44. The user may toggle the switch 54 to select either the blow dryer fan 26 or the vacuum fan 28. Using the respective input, the user may either blow hot air through the first channel 16 of the nozzle so as to dry wet hair or suction cut or fallen hair through the inlet port 22 of the second channel 20 such that it is collected in the collection chamber 32. As desired, the user may open the door 34 and empty collected hair from the collection chamber 32 into a waste receptacle.

It is understood that while certain forms of this invention have been illustrated and described, it is not limited thereto except insofar as such limitations are included in the following claims and allowable functional equivalents thereof.

I claim:

1. A hair dryer and vacuum device for selectively drying hair and vacuuming fallen hair, comprising:
a housing having a nozzle, a handle, and a body portion situated between said handle and said nozzle;
wherein said nozzle includes a first channel extending from said body portion to an outlet port and a second channel extending from said body portion to an inlet port;
a heating coil mounted in said body portion for heating air;
a dryer fan positioned adjacent to said heating coil that is configured to blow said heated air from said body portion through said first channel outlet port when energized;
a vacuum fan mounted in said second channel that is configured to draw air into said second channel through said second channel inlet port when energized;
a collection chamber situated between said vacuum fan and said body portion and in communication with said second channel such that fallen hair is collected therein.

2. The hair dryer and vacuum device as in claim 1, further comprising a door coupled to said body portion that is movable between open and closed configurations such for selectively emptying collected hair from said collection chamber.

3. The hair dryer and vacuum device as in claim 1, wherein said body portion defines a vent opening in communication with said body portion through which ambient air is drawn when said dryer fan is energized.

4. The hair dryer and vacuum device as in claim 3, further comprising a filter situated between said vent opening and said dryer fan such that contaminants are prevented from being blown through said first channel.

5. The hair dryer and vacuum device as in claim 2 wherein:
said door includes a fastener; and
said body portion defines a groove having a configuration complementary to said fastener for selectively securing said door in said closed configuration.

6. The hair dryer and vacuum device as in claim 4, further comprising a grill member situated in said outlet port.

7. The hair dryer and vacuum device as in claim 1 further comprising a battery situated in said handle and electrically connected to said dryer fan, said heating coil, and said vacuum fan.

8. The hair dryer and vacuum device as in claim 1 further comprising an AC electric power plug electrically connected to said dryer fan, said heating coil, and said vacuum fan.

9. The hair dryer and vacuum device as in claim 1 further comprising a first input electrically connected to said dryer fan.

10. The hair dryer and vacuum device as in claim 9, further comprising a second input electrically connected to said vacuum fan.

11. The hair dryer and vacuum device as in claim 10, further comprising a switch electrically connected to said first and second inputs.

12. A hair dryer and vacuum device for selectively drying hair and vacuuming fallen hair, comprising:
a housing having a nozzle, a handle, and a body portion situated between said handle and said nozzle;
wherein said nozzle includes a first channel extending from said body portion to an outlet port and a second channel extending generally from said body portion to a distal end defining an inlet port;
wherein said first channel is in communication with a interior area defined by said body portion and second channel is not in communication with said interior area;
a heating coil mounted in said body portion for heating air;
a dryer fan positioned adjacent to said heating coil that is configured to blow said heated air from said body portion through said first channel outlet port when energized;
a vacuum fan mounted in said second channel that is configured to draw air into said second channel through said second channel inlet port when energized;
a collection chamber situated between said vacuum fan and said body portion and in communication with said second channel such that fallen hair is collected therein;
a power source electrically connected to said dryer fan and said vacuum fan;
a first input electrically connected to said dryer fan;
a second input electrically connected to said vacuum fan;
a switch electrically connected to said first and second inputs that selectively directs current from said power source to either said first or said second input.

13. The hair dryer and vacuum device as in claim 12 further comprising an insert configured to selectively cover said second channel inlet port.
